(19) United States
(12) Patent Application Publication
(10) Pub. No.: US 2023/0407836 A1
(43) Pub. Date: Dec. 21, 2023

(54) FLOATING INDEPENDENT X-SHAPED SELF-ALIGNING MULTIPLE HYDRO-GENERATOR WITH MAXIMUM THRUST SURFACE

(71) Applicant: José Manuel MONTERO GÓMEZ, Churriana de la Vega (ES)

(72) Inventor: José Manuel MONTERO GÓMEZ, Churriana de la Vega (ES)

(21) Appl. No.: 18/030,290

(22) PCT Filed: Oct. 11, 2021
(86) PCT No.: PCT/ES2021/070740

§ 371 Date: Apr. 5, 2023

(30) Foreign Application Priority Data
Oct. 15, 2020 (ES) U202032234

(51) Int. Cl. F03B 17/06

(52) U.S. Cl. CPC F03B 17/067; F05B 2240/93; F05B 2240/40

(57) ABSTRACT

A floating independent X-shaped self-aligning multiple hydro-generator with maximum thrust surface that generates electrical power by using river and sea currents, regardless of the direction thereof, not requiring a supporting structure on the seabed, and enabling the maintenance thereof above the surface of the water. The hydro-generator of the present invention is formed by at least one floating X-shaped structure with four arms, there being at the end of each an electrical generator driven by a mechanism for the conversion of the linear movement of a fluid into the rotational movement of a shaft, the conversion mechanisms being arranged in a clockwise direction around the shaft of the X-shaped structure, each of these being configured for an alternating clockwise or counter-clockwise direction of rotation, having a tube attached to the lower side of the X-shaped structure with a plate attached thereto.

### CROSS REFERENCE TO RELATED APPLICATION

The present application is a U.S. national stage application of PCT International Application No. PCT/ES2021/070740, filed Oct. 11, 2021, and published as PCT Publication WO/2022/079332 on Apr. 21, 2022, which claims priority to Spanish Application No. U202032234, filed on Oct. 15, 2020. The disclosures of all the foregoing applications are hereby incorporated by reference in their entirety into the present application.

### TECHNICAL SECTOR

The disclosed invention falls within the field of renewable energy production systems, specifically in the field of hydroelectric energy and devices for the generation of energy from water currents in rivers and seas.

### BACKGROUND OF THE INVENTION

The production of energy from renewable sources has become increasingly important in global energy production over time and is key to the sustainability of the energy system and the fight against climate change.

One example of renewable energy that has been used for centuries is the harnessing of the energy of water currents in rivers and canals and converting it into mechanical energy. Hydroelectric power in particular, i.e., the harnessing of water currents in waterfalls and their conversion into mechanical energy by means of turbines and in turn into electrical energy by means of alternators, is one of the main sources of renewable energy in use today.

In the seas and in the oceans, there are also various forms of harnessing water energy, for example by harnessing the tides (tidal energy), waves (wave energy) and ocean currents. In these cases, the level of harnessed energy in relation to the economic and environmental cost of the systems needed to extract it has made it difficult to implement.

Especially in the case of harnessing both sea and river currents and converting them into electrical energy, various types of devices have been developed, some on a small scale and others on a large scale, depending on the environment and the level of energy produced.

These devices are normally based on turbines with rotors of various geometries linked to alternators or electric generators. In general, they are completely submerged and fixed to the ocean, sea, or river bottoms. The disadvantage of this type of design is that, as all the mechanical and electrical equipment is below the surface of the water, maintenance work is complicated, and the danger of short circuits and corrosion increases. In addition, electrical connections have to be made underwater, which is highly complex and costly.

On the other hand, such equipment is generally fixed in a rigid position and can therefore suffer or cause damage from extreme impacts. In addition, they often require a support structure from the seabed or river bottom with a high environmental impact. In some cases, the device blocks the water current, not maintaining a passage for fauna and hindering the passage of ecological flows in the case of being used in rivers.

From a performance point of view, existing equipment tends to operate in only one direction, the direction of the water flow, which limits the time of use of the water flow and the locations in which it can be used. On the other hand, existing equipment has a high resistance to drifting in the water flow, which also makes it difficult to orientate the equipment in relation to the water flow.

Therefore, in the case of allowing a change of orientation, complicated maneuvers necessary for optimal orientation in direction and direction in the face of changing water currents.

Finally, in many cases, the equipment often converts electrical energy to a single generator, which means less production flexibility and total system failure in the event of a breakdown.

It is for all these reasons that there is a need in the market for the production of electrical energy through equipment that, by taking advantage of marine and river currents, overcomes the disadvantages described above, allowing the use of currents regardless of their orientation and having little resistance to “drift” by the current.

It is also desirable that they can be fixed flexibly and reduce their environmental impact without needing a support structure from the seabed or river bottom, and without blocking the current, maintaining a passage for fauna and an ecological flow in the case of applications in rivers, and additionally allowing mechanical and electrical maintenance above the water surface, with several alternators that allow greater flexibility of use.

As a background, there is the invention ES1140760U on a mechanism for converting the linear motion of a fluid into the rotational motion of a shaft, which, although it does not have the features described above on its own, may form part of a larger device, which does have them.

### DESCRIPTION OF THE INVENTION

The disclosed invention is directed to systems, methods, and apparatus for obtaining an independent multiple hydro-generator on a floating blade with a maximum thrust surface and self-orientable, which generates electrical energy by taking advantage of marine and river currents independently of their orientation and having little resistance to drifting by the current.

The disclosed invention is further directed to systems, methods, and apparatus for obtaining an independent multiple hydro-generator on a floating blade with maximum thrust surface and self-orientable, which can be fixed in a flexible way, thus reducing damage from external impacts, and has a reduced environmental impact as it does not need a support structure from the sea or river bottom and does not block the current, maintaining a passage for fauna and an ecological flow in the case of applications in rivers.

The disclosed invention is further directed to systems, methods, and apparatus for obtaining is to obtain an independent multiple hydro-generator on a floating blade with a maximum thrust surface and self-orientable that allows its electrical connection, as well as its mechanical and electrical maintenance above the surface of the water, having several alternators that allow greater flexibility of use.

The independent multiple hydro-generator on a floating blade with a maximum thrust surface and self-orientable which is the subject of the disclosed invention is formed, at least, by a floating structure in the form of a blade with four arms at each end of which there is an electric generator whose shaft is driven by the device defined in the document ES1140760U Mechanism for the conversion of the linear movement of a fluid into the rotational movement of a shaft, which we will refer to hereinafter as the “conversion mechanism”.

As described in ES1140760U, each of the conversion mechanisms basically consists of a rotor with four arms attached to a main rotation axis, the ends of which incorporate oscillating thrust pieces that act as blades.

Considering the conversion mechanisms arranged clockwise around the central axis of the blade, each of them is configured for clockwise or counter clockwise rotation alternately. That is, if one rotates clockwise, the next rotates counter clockwise, the next rotates clockwise and the last rotates counter clockwise.

This configuration of four generators and counter-rotating vane-shaped converter mechanisms allow maximum use to be made of the thrust surface opposite the water flow.

A tube of a length greater than the depth reached by the conversion mechanisms is attached to the bottom of the central part of the structure in the form of a cross. This tube is partially closed at its lower end and has a chain or mooring cable attached to its central axis to the anchor or bottom anchor. This tube has two openings for the incoming and outgoing electrical cables.

The tube has a fixed plate attached to it along the entire length of its generatrix and located at the mid-position of the imaginary line joining two adjacent conversion mechanisms clockwise about the axis of the blade.

The forces acting on the fixed plate rotate the assembly so that it always faces the entire cross-section of the maximum thrust surface perpendicular to the direction of the water flow, which enters from one side of the imaginary square formed by the four converter mechanisms.

The counter clockwise alternation of the direction of rotation of the conversion mechanisms in the blade configuration with fixed plate thus forces the assembly to orient itself by offering one of the sides of the imaginary square formed by the four generators in the direction of flow of the water current, maximizing the thrust surface of this current and, therefore, the production of energy.

Each of the electrical generators is accessible out of the water by means of a hatch at the top of the floating blade-shaped structure.

The floating, vane-shaped structure has a dome in its center, which is also accessible through a hatch, in the interior of which the connections, couplings and electrical processing of the electrical energy waves produced independently by each of the electrical generators are carried out.

The electrical waves produced by the four independent generators can be treated electrically and coupled in series, in parallel or in mixed configuration, depending on the speed of the water flow at any given moment (even at low speeds) for maximum energy utilization.

The device thus described has the main advantages of the invention, as well as other additional advantages, such as its lack of impact on the seabed, its low visual impact, and its simple construction, not requiring dams or civil works to channel the water currents.

It is also a modular system that can be connected to other similar equipment and can produce energy continuously as long as there is water flow in any direction and direction.

Finally, the device provides space for power electronics elements, transformers, etc., enabling connection to the distribution network either in direct current with the maximum possible voltage and transformation to earth, or in alternating current with transformation in each group and output at the highest possible voltage or at mains voltage.

Throughout the description and the claims, the word “comprising” and its variants are not intended to exclude other technical features, components or steps. To those skilled in the art, other objects, advantages and features of the invention will be apparent in part from the invention and in part from the practice of the invention. The following examples and drawings are provided by way of illustration and are not intended to restrict the disclosed invention. Furthermore, the invention covers all possible combinations of particular and exemplary embodiments indicated herein.

### BRIEF DESCRIPTION OF THE DRAWINGS

In order to complement the description herein and to assist in a better understanding of the features of the invention, a set of drawings is attached hereto as an integral part of the said description, in which the following is illustratively and non-limitingly depicted:

FIG. 1a shows an elevation view of an exemplary embodiment of the self-orienting, maximum thrust area floating blade independent multiple hydro-generator of the disclosed invention.

FIG. 1b shows a top plan view of an exemplary embodiment of the self-orienting, maximum thrust area floating blade independent multiple hydro-generator of the disclosed invention.

FIG. 1c shows a lower plan view of an exemplary embodiment of the self-orienting, maximum thrust area floating blade independent multiple hydro-generator of the disclosed invention.

FIG. 1d shows a side view of an exemplary embodiment of the self-orienting, maximum thrust area floating blade independent multiple hydro-generator of the disclosed invention.

FIG. 2 shows a top perspective view of an exemplary embodiment of the self-orienting, maximum thrust area floating blade independent multiple hydro-generator of the invention.

### DETAILED DESCRIPTION OF THE INVENTION

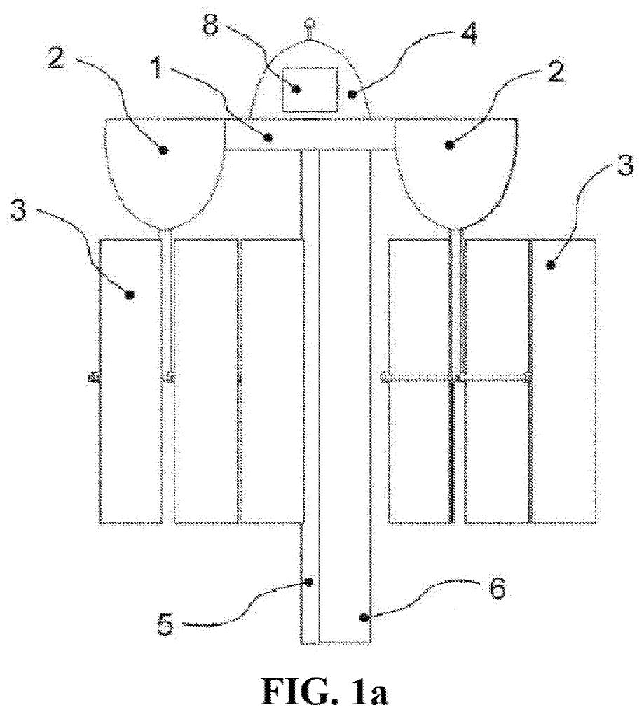

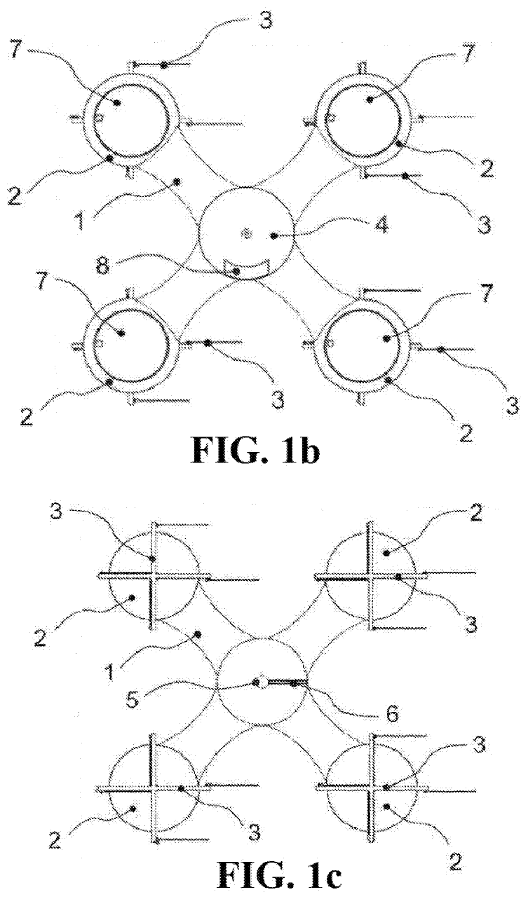

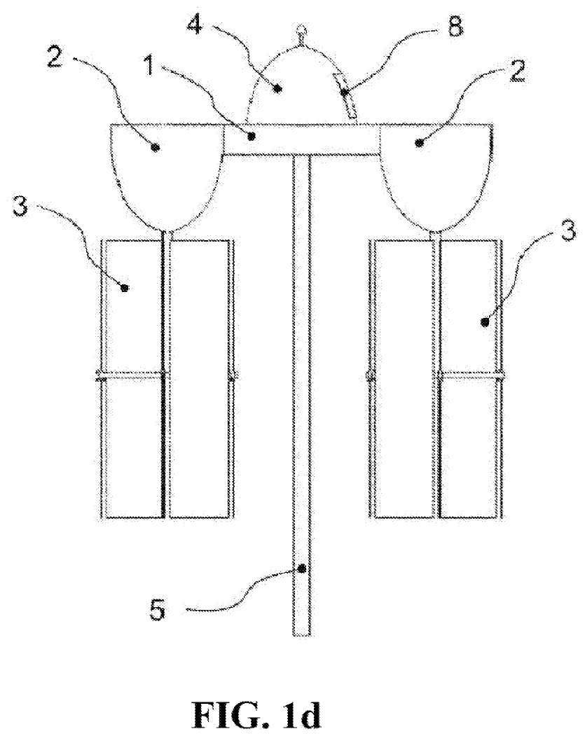

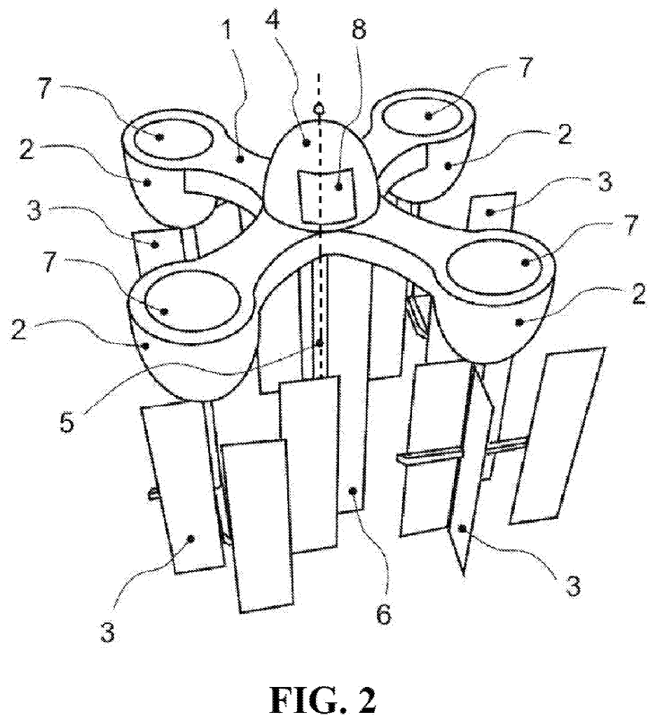

Using the numbering adopted in FIGS. 1 and 2 of the present documents to identify the elements that make up the floating blade independent multiple hydro-generator with maximum thrust surface and self-orientable which is the subject of the invention, we proceed to the description of these elements for an exemplary embodiment of the invention.

In an exemplary embodiment of the invention, the self-orientable floating blade independent multiple hydro-generator with maximum thrust surface and self-orientable consists of at least a floating blade-shaped structure (1) with four arms at each end of which there is an electric generator (2) driven by a mechanism for converting the linear motion of a fluid into the rotational motion of a shaft (3).

Considering the conversion mechanisms (3) arranged clockwise around the central axis of the blade (1), each of them is configured to rotate clockwise or counter clockwise alternately. That is to say, if one turns clockwise, the next one will turn counter clockwise, the next one clockwise and the last one counter clockwise.

In an exemplary embodiment of the invention, a tube (5) of a length greater than the depth reached by the conversion mechanisms (3) is attached to the central part of the vane-shaped structure (1) on its underside. This tube (5) is partially closed at its lower end and has a chain or mooring cable attached to its central axis to the anchor or bottom Deadman. This tube (5) has two openings for the inlet and outlet electrical cables.

The tube (5) has a fixed plate (6) attached to it along the entire length of its generatrix and located at the mid-position of the imaginary line joining two mechanisms of (3) adjacent to each other clockwise about the axis of the blade (1).

The forces acting on the fixed plate (6) rotate the assembly so that it always faces the entire cross-section of the maximum thrust surface perpendicular to the direction of the water flow, which enters through one side of the imaginary square that would form the four conversion mechanisms (3).

The counter clockwise alternation of the direction of rotation of the conversion mechanisms (3) in the blade configuration (1) with fixed plate (6) thus forces the assembly to orient itself by offering one of the sides of the imaginary square formed by the four generators in the direction of flow of the water current, maximizing the thrust surface of this current and, therefore, the production of energy.

Each of the electrical generators (2) is accessible out of the water through a hatch (7) at the immediate top of the floating blade-shaped structure (1).

The floating blade-shaped structure (1) has at its center and out of the water a dome (4), also accessible through a hatch (8), inside which the connections, couplings and electrical treatment of the electrical energy waves produced independently by each of the electrical generators (2) are carried out.

In an exemplary embodiment of the invention, the electrical waves produced by the four independent generators (2) can be treated electrically and coupled in series, in parallel or in a mixed configuration, depending on the speed of the water flow at any given moment (even at low speeds) for maximum energy exploitation.

1-6. (canceled)

7. Independent multiple hydro-generator on a floating blade with maximum thrust surface and self-orienting employing a series of mechanisms for converting the linear motion of a fluid into the rotational motion of a shaft,
characterized in that it comprises at least one floating blade-shaped structure with four arms at each end of which is an electric generator driven by a conversion mechanism, and,
the conversion mechanisms being arranged clockwise around the central axis of the blade,
each of them is configured to rotate clockwise or counter clockwise alternately,
whereby if one rotates clockwise, the next rotates counter clockwise, the next rotates clockwise and the last rotates counter clockwise.

8. Independent multiple hydro-generator on a floating blade with maximum thrust surface and self-orienting according to claim 1, characterized in that from the central part of the blade-shaped structure a tube of a length greater than the depth reached by the conversion mechanisms is fixed on its lower face, to which is attached a fixed plate along the entire length of its generatrix and located at the mid-position of the imaginary line joining two adjacent conversion mechanisms clockwise about the axis of the blade, so that the forces acting on the fixed plate rotate the assembly so that it always faces the entire cross-section of the maximum thrust surface perpendicular to the direction of the water flow, which enters through one side of the imaginary square that would form the four converter mechanisms.

9. Independent multiple hydro-generator on a floating blade with maximum thrust surface and self-orienting according to claim 7, characterized in that the tube is partially closed at its lower end and has a chain or mooring cable attached to its central axis to the anchor or dead at the bottom, with said tube having two openings for the inlet and outlet electrical cables.

10. Independent multiple hydro-generator on a floating blade with maximum thrust surface and self-orienting according to claim 8, characterized in that the tube is partially closed at its lower end and has a chain or mooring cable attached to its central axis to the anchor or dead at the bottom, with said tube having two openings for the inlet and outlet electrical cables.

11. Independent multiple hydro-generator on a floating blade with maximum thrust surface and self-orienting according to claim 7, characterized in that each of the electric generators is accessible out of the water by means of a hatch on the immediately upper part of the floating blade-shaped structure.

12. Independent multiple hydro-generator on a floating blade with maximum thrust surface and self-orienting according to claim 7, characterized in that the floating blade-shaped structure has at its center and out of the water a dome also accessible through a hatch, inside which the connections, couplings and electrical treatment of the electrical energy waves produced independently by each of the electrical generators are carried out.

13. Independent multiple hydro-generator on a floating blade with maximum thrust surface and self-orienting according to claim 7, characterized in that the electrical waves produced by the four independent generators can be treated electrically and coupled in series, in parallel or in a mixed configuration, depending on the speed of the water current at any given moment, for maximum energy exploitation.

14. Independent multiple hydro-generator on a floating blade with maximum thrust surface and self-orienting according to claim 8, characterized in that the electrical waves produced by the four independent generators can be treated electrically and coupled in series, in parallel or in a mixed configuration, depending on the speed of the water current at any given moment, for maximum energy exploitation.

15. Independent multiple hydro-generator on a floating blade with maximum thrust surface and self-orienting according to claim 9, characterized in that the electrical waves produced by the four independent generators can be treated electrically and coupled in series, in parallel or in a mixed configuration, depending on the speed of the water current at any given moment, for maximum energy exploitation.

16. Independent multiple hydro-generator on a floating blade with maximum thrust surface and self-orienting according to claim 10, characterized in that the electrical waves produced by the four independent generators can be treated electrically and coupled in series, in parallel or in a mixed configuration, depending on the speed of the water current at any given moment, for maximum energy exploitation.

17. Independent multiple hydro-generator on a floating blade with maximum thrust surface and self-orienting according to claim 11, characterized in that the electrical waves produced by the four independent generators can be treated electrically and coupled in series, in parallel or in a mixed configuration, depending on the speed of the water current at any given moment, for maximum energy exploitation.

18. Independent multiple hydro-generator on a floating blade with maximum thrust surface and self-orienting according to claim 12, characterized in that the electrical waves produced by the four independent generators can be treated electrically and coupled in series, in parallel or in a mixed configuration, depending on the speed of the water current at any given moment, for maximum energy exploitation.
